(19) United States
(12) Patent Application Publication
(10) Pub. No.: US 2015/0146499 A1
(43) Pub. Date: May 28, 2015

(54) Thermally Enhanced Lime Slurry Apparatus

(71) Applicant: Lhoist North America, Inc., Fort Worth, TX (US)

(72) Inventors: Bobby Lawrence Crabb, Clifton, TX (US); Donald Craig Dunlap, Woodway, TX (US)

(73) Assignee: Lhoist North America, Inc., Fort Worth, TX (US)

(21) Appl. No.: 14/292,186

(22) Filed: May 30, 2014

Related U.S. Application Data
(60) Provisional application No. 61/908,352, filed on Nov. 25, 2013.

(51) Int. Cl. B01F 15/02

(52) U.S. Cl. CPC B67D 7/80; B65D 88/128; B67D 7/62; B67D 7/84
USPC 366/191

(57) ABSTRACT

A single entity lime slurry transport and delivery apparatus is shown having a slurry tank body mounted on a unitary frame. A suction pump on the apparatus delivers slurry to a job site. A power unit on the frame powers a hydraulic mixing motor and the hydraulic suction pump. Selectable thermal management devices are located on the unitary frame, including at least a fuel heater, an engine coolant water heater, a hydraulic fluid warmer and heat exchanger, and heating elements associated with other hydraulic components of the apparatus.

### RELATED APPLICATIONS

The present U.S. patent application claims priority to U.S. Provisional Patent Application No. 61/908,352 and entitled THERMALLY ENHANCED LIME SLURRY APPARATUS, filed Nov. 25, 2013 in the name of the same inventors named in the present application.

### BACKGROUND OF THE INVENTION

1. Field of the Invention

The present invention relates generally to the transportation and use of lime slurry and to a portable transport mixing and dispensing apparatus used to provide slurry at a job site.

2. Description of the Prior Art

Calcium based compounds such as CaO and Ca(OH)₂ have many practical uses. For instance, these substances are used in treating waste water and sewage, as soil neutralizing agents and nutrients, for ground stabilization for construction, and as components of building materials.

Calcium oxide, (CaO), is often referred to as “quicklime”, while calcium hydroxide, Ca(OH)₂, is referred to as “hydrated lime”, both sometimes being informally referred to as “lime”. Quicklime is usually in the form of lumps or pebbles. Dry hydrated lime is usually a powder. In order to further process these compounds and improve the ease with which they are handled, dry CaO or dry Ca(OH)₂ is usually mixed with water to form a slurry. In the case of quicklime, the water reacts with the quicklime in an exothermic reaction to form hydrated lime. This is often referred to as “slaking.” During the slaking of quicklime, large amounts of heat are generated which can significantly raise the temperature of the slurry.

Lime slurries can be made in batches or in a continuous process. If a particular user requires a large amount of lime slurry at a particular site, large capacity slaking and storage tanks can be permanently located on the site. These tanks can usually provide a sufficient supply of lime and lime slurry for most operations. Often, however, it is not practical to provide permanent slaking or storage tanks for forming lime slurries in particular end use situations. For example, in the agricultural industry and in some construction industries, lime may be required only periodically or during certain seasons. Here, the limited use of lime may not justify the investment required for construction and maintaining large capacity processing tanks and equipment. Also, the location of the job sites may change from day to day.

One particular agricultural end use concerns treated crop residues (corn, wheat straw, cotton burrs, etc.). For example, corn stover has recently been found to provide a high-fiber, low-energy dairy heifer and dry cow feed. Corn “stover” consists primarily of the leaves and stalks of maize plants left in a field after harvest and consists of the residue: the stalk; the leaf, the husk, the cob and perhaps some kernels remaining in the field following harvest. On-going research has shown that a substantial portion of the grain in cattle feed can be replaced with treated crop residue that has been treated with hydrated lime. Adding hydrated lime which has been diluted with water to crop residue renders the plant material sufficiently digestible so that it can constitute a sizable fraction of the cattle ration.

The treatment of crop residues provides a need for a portable apparatus for providing the lime slurry which is used in the treatment process. Portable equipment for forming lime slurries which can be moved from site to site, is described in a number of prior art references, including Teague et al. (U.S. Pat. No. 4,329,090), Shields et al. (U.S. Pat. No. 5,507,572) and Scholl et al. (U.S. Pat. No. 6,412,974). While devices of this type have been used for many years in the soil stabilization industries, they tend to be large and somewhat cumbersome when used in smaller applications. Sometimes, the earlier equipment required several pieces of equipment that need to be hauled separately, thus requiring more manpower and expense to operate. Such factors tended to limit the commercial applicability of the devices to larger sites and larger projects. Smaller projects and sites where space is limited, or where the job site changes from day to day, have created a need for a smaller version of the existing larger transportable lime slurry devices.

Another problem encountered in the case of corn stover and other crop residue treatment concerns the ambient temperature in the job location environment. Many of the large corn growing areas of the country are in the upper Mid-West, for example, Iowa, Nebraska, Illinois and Minnesota to name a few states. The winter time temperatures in these states, after crops have been gathered, is often below freezing. The prior art portable lime slurry mixing devices typically lacked any type of heating equipment to ensure that the hydrated lime slurry remained pumpable and did not freeze or form obstructions in the equipment lines or pumps. There was also sometimes a freezing hazard associated with the engine water used in the coolant system of the engine used to turn the agitator paddle shaft of the device and with a thickening of the hydraulic fluids used in the various hydraulic lines associated with the operative components of the device.

Thus, a need continues to exist for further improvement in the equipment and processes used in transporting and dispensing lime slurry. What is needed is an easily transportable device that can expand the practical commercial use of lime slurries at remote sites, such as in an agricultural setting of the type previously described.

The preferred apparatus would be capable of being operated by one man and would be self-contained such that all the power sources and equipment necessary for the slurry operation are on one unit. There would be adequate thermal safeguards to ensure that the engine water, as well as the flow lines and associated pumping equipment, would not thicken to a significant extent or freeze in winter time operation or that components would not overheat in the summer.

This invention is directed towards such an improved apparatus and method for transporting and dispensing lime slurries.

### SUMMARY OF THE INVENTION

Accordingly there is provided a thermal management system for a mobile, self-contained lime slurry transport apparatus, comprising a self-contained transport apparatus configured to transport and dispense lime slurry to remote job sites, the apparatus supported on a frame of a wheeled chassis and comprising at least a slurry tank having an internal agitator and a slurry dispensing pump driven respectively by a first and a second hydraulic motor, and a hydraulic system powered by a first internal combustion engine. The apparatus includes a combination of selectable thermal management devices disposed on the frame of the wheeled chassis and operative to control one or more of at least the temperatures of hydraulic fluid, engine fuel, and engine coolant.

In one aspect the thermal management devices include one or more heating devices selected from the group consisting of a hydraulic fluid warmer, an engine fuel heater, an engine coolant heater, and a heat exchanger for limiting temperature rise of the hydraulic fluid.

In another embodiment, there is provided a thermal management system for a single-entity reactor apparatus configured to transport and dispense lime slurry to remote job sites, the reactor apparatus supported on a frame of a wheeled chassis and comprising at least a tank body and a hydraulic tank and hydraulic pump assembly driven by a first internal combustion engine, wherein the thermal management system comprises a combination of selectable thermal management devices disposed on the frame of the wheeled chassis and operable to control the temperatures of engine fuel, engine coolant, hydraulic fluid, and water. These thermal management devices include an engine fuel heater;

an engine coolant heater; a hydraulic fluid heater; a heat exchanger for the hydraulic fluid; and a layer of thermal insulation disposed on respective conduits for engine fuel, engine coolant, and hydraulic fluid.

Additional objects, features and advantages will be apparent in the written description which follows.

### BRIEF DESCRIPTION OF THE DRAWINGS

FIG. 1 is a side, elevation view of the improved apparatus of the invention shown in position at a job site with the landing gear extended;

FIG. 2A is an enlarged side view of a forward portion of the apparatus of FIG. 1;

FIG. 2B is an enlarged side view of the opposite side of the forward portion of FIG. 1;

FIG. 3 is a view toward the rearward end of the apparatus of FIG. 1, with the back wall and entrance door of the insulated pump room removed;

FIG. 4 is a schematic diagram of the hydraulic, fuel, and engine coolant fluid circuits involved in the thermal management apparatus and processes incorporated in the embodiment of FIGS. 1, 2A and 2B, and 3;

FIG. 5 is a plan view schematic diagram of the insulated pump room depicted in FIG. 3; and

FIG. 6 is a schematic diagram of the electrical circuits associated with the fluid circuits depicted in FIG. 4.

### DETAILED DESCRIPTION OF THE INVENTION

The preferred version of the invention presented in the following written description and the various features and advantageous details thereof are explained more fully with reference to the non-limiting examples and as detailed in the description which follows. Descriptions of well-known components and processes and manufacturing techniques are omitted so as to not unnecessarily obscure the principle features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

### INTRODUCTION

The present invention is a single-entity lime slurry transport and delivery apparatus for delivery of lime slurry to remote job sites. The apparatus of the invention comprises a unitary frame of a trailer substantially parallel to the ground and having a horizontal axis. A tank body is attached to the frame, the tank body having a horizontal axis parallel to the horizontal axis of the frame, a generally cylindrical exterior, and an interior surface. The tank body interior forms a mixing chamber. A mixing device, such as a power auger or paddle shaft, is located within the tank interior. A power unit is attached to the device in order to make it self-contained. The power unit, typically a diesel powered engine, is coupled to the frame for powering hydraulic units such as the auger or other mixer and the suction pump used to dispense wet slurry product. A transport means, such as a tractor, may be used to transport the apparatus to a jobsite. The tractor or other towing vehicle may be attached to a trailer hitch arrangement installed at the forward end of the slurry transport. Also, in the embodiment shown, dual wheeled axles equipped with inflatable air bags that act as air springs may preferably be located at the rear of the transporter to act in cooperation with the landing gear during the parking and leveling operations.

In order to make the apparatus both appropriate for the highway and a mixing apparatus at a jobsite, a vertical placement component such as the type of landing gear typically used on long trailers is provided. The landing gear is used for supporting the frame, tank body, and power unit in a working position once at a jobsite. In a raised position when pulling the apparatus on a highway, the trailer's frame and tank body clear the ground surface sufficiently to travel on a highway.

A wet slurry inlet and a metered, wet product outlet are provided at one end of the tank body. In this way, previously slaked wet lime slurry can be introduced into the tank interior, the apparatus then being used to transport the wet lime slurry to the ultimate job site where solids in the slurry are maintained in suspension by powering the auger mixer in the tank interior. A suitable dispensing component or components are attached to the wet product delivery outlet, for example, a flexible hose. The hose can be used to dispense the lime slurry onto, for example, crop residue, using the agricultural example discussed in the background of the invention. While a preferred use of the apparatus of the invention is as a transport, mixing and dispensing device, it may also be used in some circumstances as the slaking vessel itself. In such case, the lime inlet is typically arranged to extend beneath the surface of the mixing water in the tank, such that solid lime can be introduced below the surface of a slurry formed within the mixing chamber.

The improved apparatus of the invention is also thermally enhanced to assure a supply of lime slurry in either extremes of cold or hot weather at a remote job site by providing several types of auxiliary heating and cooling of critical components of the apparatus, as may be required depending upon the existing environmental conditions. At least three types of auxiliary heating are available including a diesel fuel heater, an engine cooling water heater and a heating system for the system hydraulics. An electric generator located on the frame of the apparatus controls all of the components and runs the fuel heater. All valves are automated and heated. Temperature probes provide the information needed for determining when the heating components of the system should be turned on. One or more heat exchangers equipped with fans are also provided to cool the hydraulics in hot weather.

Most preferably, the power unit is a combustion engine which is coupled to a hydraulic converter, the combustion engine supplying power to the hydraulic converter. The hydraulic converter drives the mixer in the tank interior as well as the hydraulic suction pump which is used to dispense wet slurry product from the tank interior to the job site. The mixer which is provided in the tank interior is preferably an auger, comprised of a paddle shaft, located within the tank body for mixing the wet lime slurry to assist in maintaining solids in the slurry in suspension. The hydraulic converter also provides the hydraulic pressure necessary to operate a pair of hydraulic jacks or “landing gear” for use in un-hitching, parking, and leveling the transporter on a job site.

As briefly discussed in the Background section, the term “lime” can encompass quicklime (calcium oxide—CaO), hydrated lime (calcium hydroxide—Ca(OH)₂ or lime slurry. Quicklime is manufactured by chemically converting limestone (calcium carbonate—CaCO₃) into calcium oxide. Hydrated lime is created when quicklime chemically reacts with water. Lime slurry is a suspension of hydrated lime in water and can be formed from either hydrated lime or quicklime. Most lime material used for the purposes discussed herein will be “high calcium” lime, which contains no more than about 5 percent magnesium oxide or hydroxide. On some occasions, “dolomitic” lime may be used. Dolomitic lime contains about 35-46 percent magnesium oxide or hydroxide, although the magnesium fraction reacts more slowly than the calcium fraction. The preferred wet lime product slurries used herein will contain about 20-45% by weight solids, based upon the total weight of the slurry.

Methods to overcome the propensity of the lime particles to precipitate inside transportation vehicles include both mixing devices and recirculation pumps. Both methods involve mechanical means to keep the solution moving so as to prevent the lime from settling within the shipping vehicle. Should settlement occur, the resulting segregation of the water and lime particles make it difficult or impossible to properly regulate the dispersion of the slurry solution. This event also creates a great deal of maintenance problems for the vehicle operator.

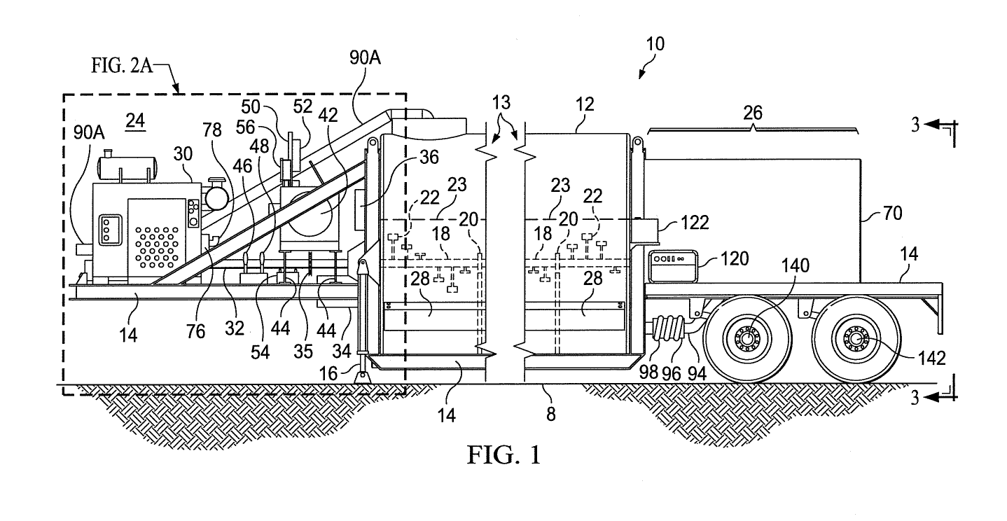

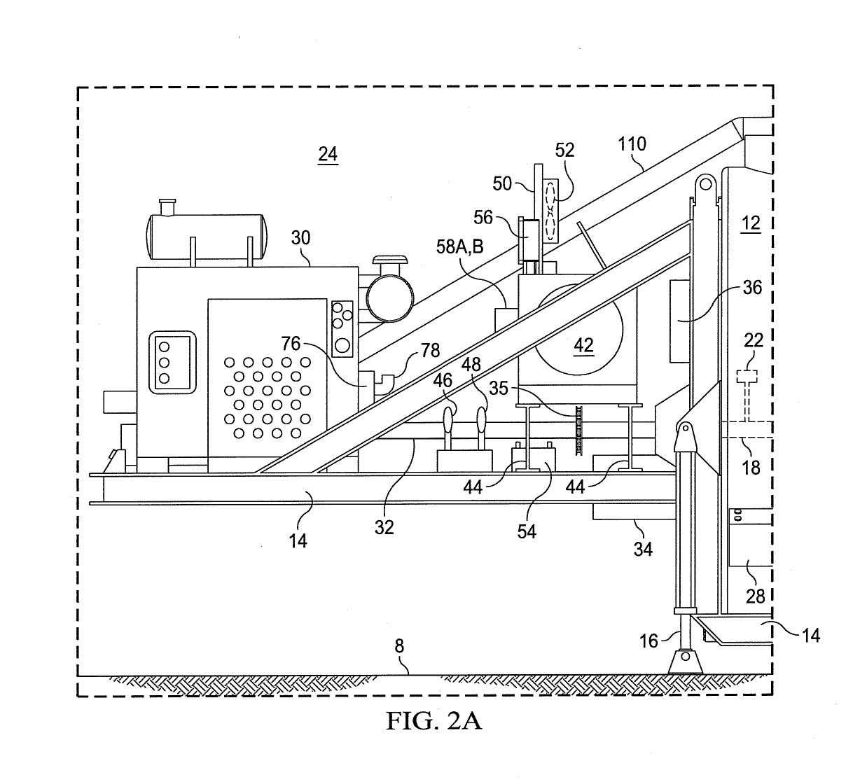

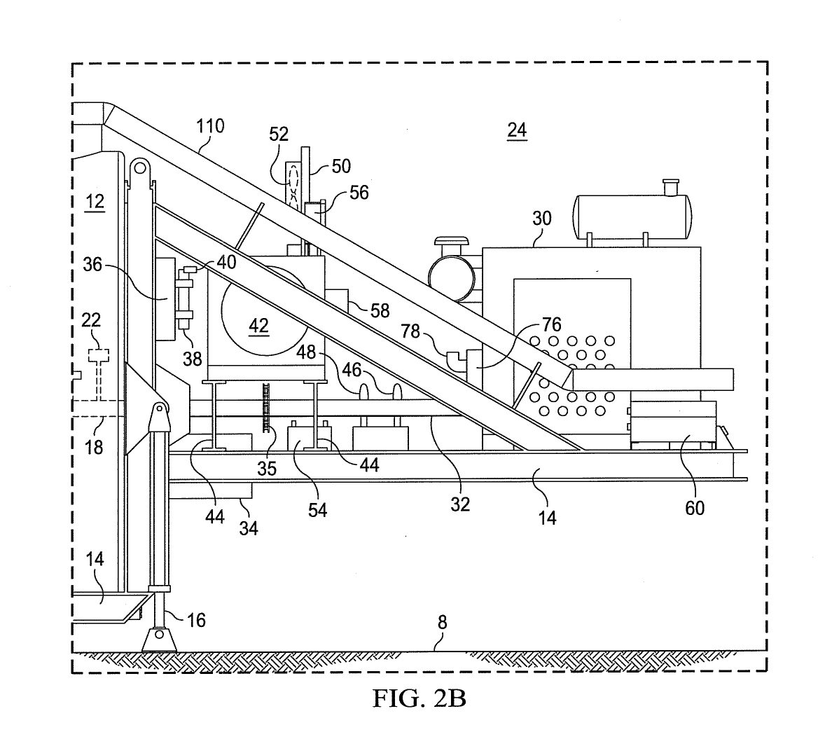

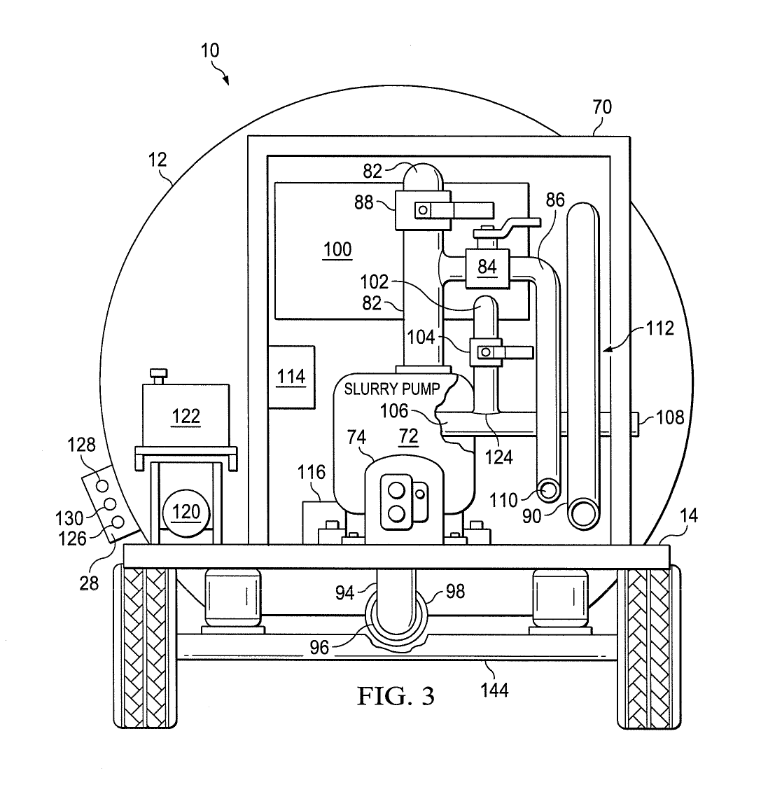

To make the use of lime slurries economically and physically practical at small construction and remote, a single-entity lime slurry transport and dispensing apparatus (hereinafter to be called a “transporter” or “single entity reactor”) 10 is needed that can be operated by one person. The design of the present invention starts with the basic concepts of a transporter disclosed by Shields et al. (U.S. Pat. No. 5,507,572) and Schholl et al. (U.S. Pat. No. 6,412,974), but with several distinctions. The design differences and advantages to the present invention are described more fully below, beginning with FIGS. 1, 2A, 2B, and 3. FIG. 1 is a side, elevation view of the improved transport apparatus 10 of the invention shown in position at a job site with the landing gear 16 extended. FIG. 2A is an enlarged side view of a forward section 24 of the apparatus of FIG. 1. FIG. 2B is an enlarged side view of the opposite side of the forward section 24 of FIG. 1. And FIG. 3 is a view looking forward at the rearward section 26 of the apparatus of FIG. 1, with the back wall and entrance door of the insulated pump room 70 removed.

### DETAILED DESCRIPTION

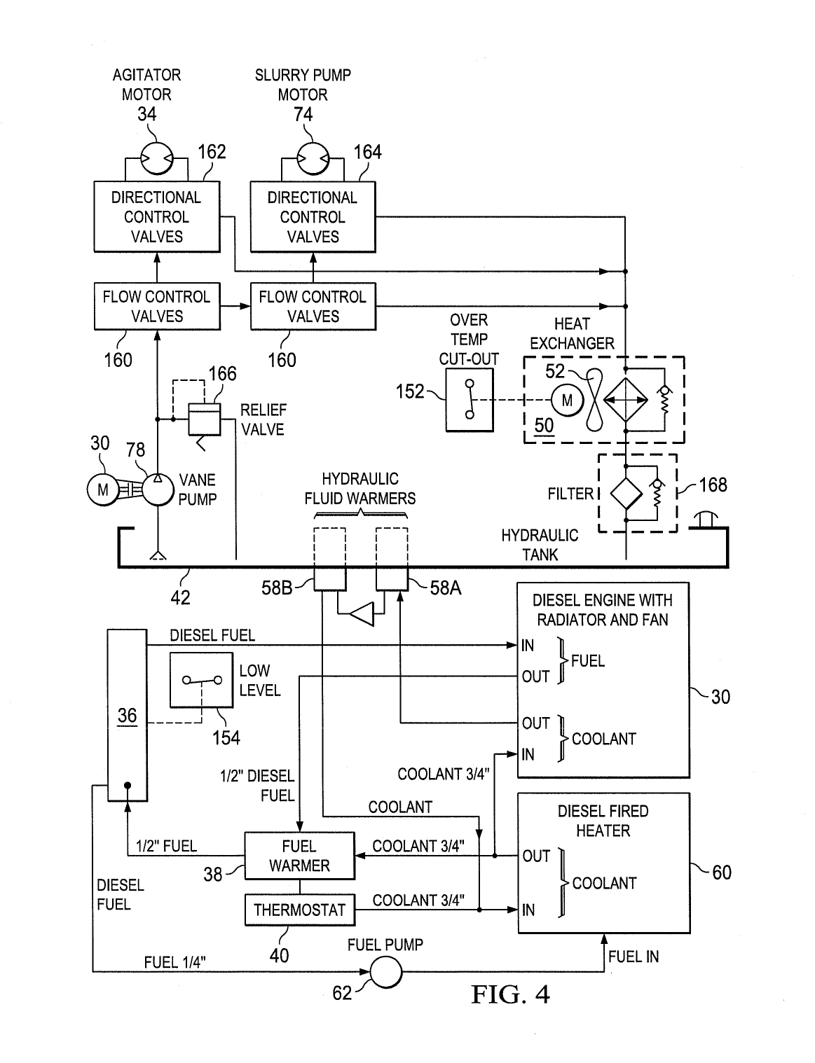

Referring to FIGS. 1, 2A, 2B, and 3, the transporter apparatus 10 used in performing the method of the invention—to transport and dispense lime slurry in all-weather conditions—is shown. It should be noted that many of the hydraulic plumbing, electrical wiring, fuel and other fluid lines or conduits are not shown in these pictorial illustrations of the major components of the invention. This approach is taken to preserve sufficient clarity in the drawings to identify the various structures of the invention. Further, these items for conducting fluids and electrical signals or power are well known in the art, so they need not be explicitly described. However, FIGS. 4, 5, and 6 depict most if not all of these conduits and connections schematically, so persons skilled in the art can readily identify the placements and components needed to supply these conduits, connections, and relationships between the various components of the apparatus.

The apparatus 10 has a unitary chassis or frame 14 that is substantially parallel to the ground, road, or highway when in use. The slurry tank body 12 (or, tank 12) is attached to the frame 14 by various fastening means such as bolts, welding, and the like. The tank body 12 may include at least one mixing chamber 13. The tank 12 in the illustrated transporter 10 is somewhat smaller than the traditional Porta Batch™ tank described in the earlier mentioned Scholl et al. and Shields patents. In one version of the apparatus of the invention, the tank body may be approximately 8 feet 6 inches in diameter and 24 feet 6 inches long and have an internal volume of approximately 10,000 gallons.

Within the mixing chamber 13 is the agitator 18 (or mixing shaft 18), the agitator 18 being configured in the present embodiment as a paddle shaft, with a plurality of paddles 22 extending perpendicularly at various intervals along the shaft 18 and extending along various radial angles. The paddle shaft or agitator 18 is supported at intervals by one or more bearing supports 20. The agitator 18 is preferably driven by a hydraulic motor—the drive unit 34—located outside the slurry tank and coupled to the agitator 18 via a chain drive 35 to the agitator shaft 32, which in turn is coupled to the agitator 18 inside the slurry tank 12. Thus the motive power of the hydraulic drive unit 34 is coupled to rotate the agitator 18. The hydraulic drive unit 34 is controlled by an agitator control lever 48.

Continuing with FIG. 1, the wet slurry product additives will fill the mixing chamber 13 to substantially cover the agitator 18 (as indicated by the line 23 in FIG. 1). Thus the agitator 18 is located in the lower half of the tank 13, within the portion of the tank occupied by the slurry. In use, the tank is never filled to capacity but only approximately half-filled (or even less) to minimize load-shifting problems during transport. For example, instead of filling the 10,000 gallon capacity, a product load of e.g. 4,000 gallons of slurry may be safely carried during travel along the roadway while avoiding problems with load shifting. Once on site and the agitator is activated, it will sufficiently agitate the slurry to avoid precipitation of the solids in the slurry and to assist in creating a more consistent mix of material.

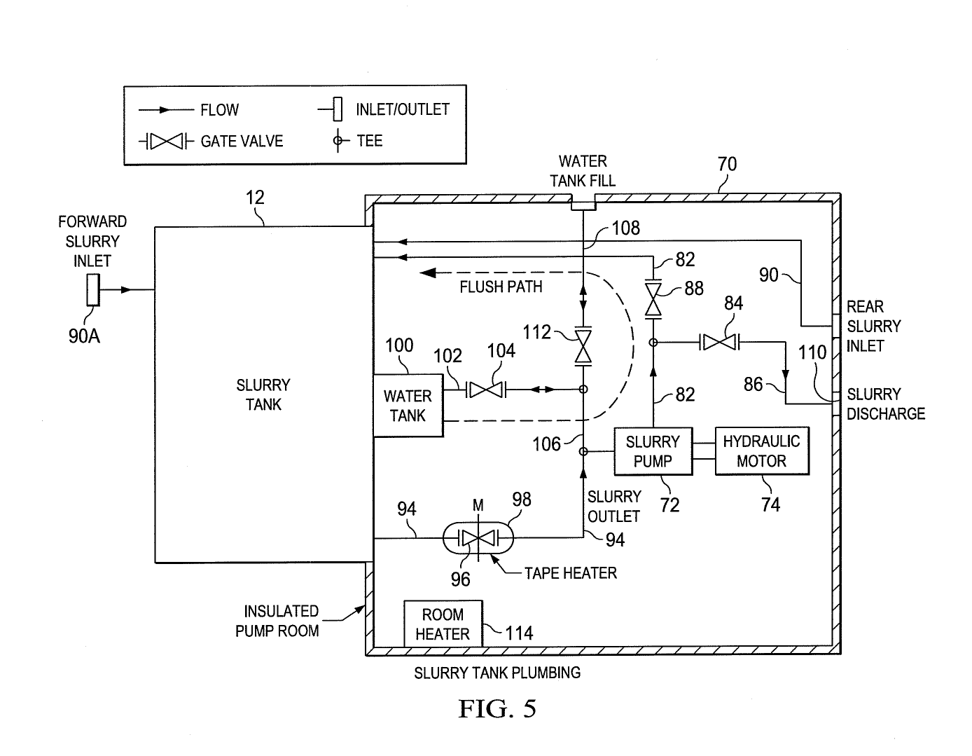

Referring to FIGS. 1, 2A, 2B, and 3, the single-entity reactor or transport 10 has a complete power unit assembly built into the apparatus, the assembly comprising hydraulic power units that are driven by an internal combustion engine. The single or multiple power units are supported on the chassis 14. In the illustrated version of the apparatus 10, the forward section 24 is used to contain at least power unit 30. Power unit 30 may be an internal combustion engine, that typically runs on diesel fuel. In the example shown, the engine may be a John Deere 70 H.P. hooded diesel engine. The power unit or engine 30 serves to power most other devices on the apparatus either directly or indirectly. Thus, the engine 30 is coupled to a hydraulic spline converter 76 and a hydraulic pump 78 that converts the torque of the engine's drive shaft into hydraulic power. This hydraulic power is then communicated through hydraulic lines to other hydraulic power units on the apparatus, such as, for example, hydraulic landing gear 16, the hydraulic motor that drives the agitator 18 inside the slurry tank 12, and the hydraulic slurry pump 72 (See FIG. 3). The slurry pump 72, which operates as a suction pump, is used to draw mixed slurry from the tank 13 to a wet product delivery and dispensing outlet 86. To fill the tank 12, the wet slurry lime to be transported is pumped into the tank interior 13 through a suitable inlet such as inlet 90 (FIG. 3) or a forward inlet 90A (FIG. 5), it being understood that other locations on the tank body may be suitable for inlets to the tank 12.

The forward section 24 shown in FIGS. 1, 2A and 2B may preferably include a trailer hitch (not shown) to be attached to a tractor or other transport vehicle capable of pulling the transport apparatus 10. The forward section 24 further contains the previously described power unit 30 and power spline converter 76. The rear section 26 shown in FIGS. 1 and 3 is used to support and enclose at least the hydraulic slurry pump (72 in FIG. 3) and its associated hydraulic motor, conduits, valves, etc. to be described. The rearward section 26 also preferably includes an electric generator (120 in FIG. 3), which in the exemplary embodiment may be an 1800 watt gasoline powered generator that supplies both 120 VAC and 12 VDC electrical power to the transport apparatus 10. The rear section 26 and all its described components except the electric generator 120 and its gasoline fuel tank 122 are enclosed in this example within an insulated room 70. Also located outside the insulated room 70 is an end view of a long horizontal enclosure 28 attached to the outside of the slurry tank 12. This enclosure 28, which may be insulated, encloses conduits for electrical lines 126 (120 VAC and 12 VDC), a hydraulic supply line 128, and a hydraulic return line 130. The insulated room 70 includes a 120 VAC electric room heater 114 to ensure the temperature remains above the freezing point of water. The view of the insulated room 70 in FIG. 3 is shown without the rear wall and a lockable entry door to clearly show the internal components of the rearward section 26 of the transport 10.

Continuing with FIG. 3, the wet slurry product is pumped from the slurry tank 12 via conduit 94 and motorized valve 96 by the hydraulic slurry pump 72 and dispensed via dispensing conduit 86. As depicted in FIGS. 1 and 3, the motorized valve 96 may be enclosed, insulated and wrapped with electrically operated heating tape 98 to ensure proper functioning in sub-freezing weather. The dispensing conduit 86 may be connected to a slurry discharge outlet 110 for dispensing slurry product to a desired location externally of the tank 12.

A fresh water storage tank 100 is also carried on the rear section 26 within the insulated room 70. When dispensing is completed the gate valve 84 is closed and fresh water from tank 100 is drawn through conduit 102 and gate valve 106 by the slurry pump 72 and routed via gate valve 88 and the remaining portion of conduit 82 to the slurry tank 12. This process cleans the slurry dispensing apparatus to prevent clogging and reduce maintenance. The water tank 100 may be filled via conduit 104 and gate valve 112. The “T” pipe connection 124 shown in FIG. 3, and its associated valve 104, allow the flush water to be discharged from outlet 108, or routed through conduit 106 through the slurry pump 72 and either the dispensing conduit 86 or for re-circulation back into the slurry tank 12 via the valve 88 and the conduit 82 to avoid discharging the used flush water into the surrounding environment. The conduit 108 may also be used to fill the flush water tank 100 via the reverse path through conduit 108, valves 112 and 104, and conduit 102. The valve 112 is not visible in FIG. 3 but is located behind a slurry inlet 90 that is provided for filling the slurry tank 12.

As shown in FIG. 1, the transport apparatus 10 may include vertical placement means—such as the first and second landing gear jacks 16, one located on each side of the chassis 14 adjacent the forward end of the slurry tank 14. The landing gears 16 are provided to support the unitary frame 14 and tank 12 of the transport 10 on the ground 8 when at a jobsite, and lifting it from the ground to re-hitch the transport in preparation for traveling on a highway. At the rearward end of the transport 10 the transport chassis 14 may be supported by first 140 and second 142 wheeled axle assemblies that may include inflatable air bags for raising and lowering the rear end of the transport 10. These vertical displacement means may be operated together as necessary to position the transport 10 either on site or for traveling. The apparatus 10 is in a working position as shown in FIG. 1 when at a job site, the transport apparatus 10 being supported by the landing gears 16A, 16B and the first and second wheeled axle assemblies 140, 142. The transport apparatus 10 may be hitched to a tractor (not shown), and transported along a roadway after the landing gear 16A, 16B are retracted using the hydraulic control lever 46 located in the forward section 24 of the transport 10.

In order to provide the wet lime slurry product, for example at a farm corn stover treatment site, the apparatus 10 is transported by means of truck or tow vehicle such as a tractor to a desired location that is remote from the lime processing/slaking operation. Once the apparatus is located at the remote job site, the apparatus is unhitched and may be lowered into its working position using the landing gears 16A, 16B controlled by the hydraulic control lever 46 and deflatable air bags associated with the wheeled axle assemblies 140, 142. The apparatus may be left at the job site for several days or even weeks, or may be part of a rotation of tank trailers which are used to supply a constant available source of wet slurry product as needed at the job site. It is even possible to use the tank as the slaking vessel, in the case where it is not desired to transport quicklime which has already been converted to hydrate slurry. The product which is dispensed from the delivery outlet 86 can be introduced into, for example crop residue, in any number of ways customary in the industry. For example, the crop residue can be moved on a conveyance device with the diluted slurry being spread or sprayed onto the moving material.

### Thermal Management

Among the improvements incorporated in the present invention are a number of thermal management devices to be described. FIGS. 4, 5, and 6 depict schematically the interconnections and relationships among these devices, while FIGS. 1, 2A, 2B, and 3 illustrate where on the transport apparatus 10 the various thermal management devices are located. Devices appearing in multiple figures are assigned the same reference number to enable ready identification. The operation of these thermal devices is generally selectable according to sensors, thermostats, timers and the like to enable versatile control under a variety of conditions, including both very cold and warm weather to provide an all-weather capability regardless of the geographical region in which it is operated.

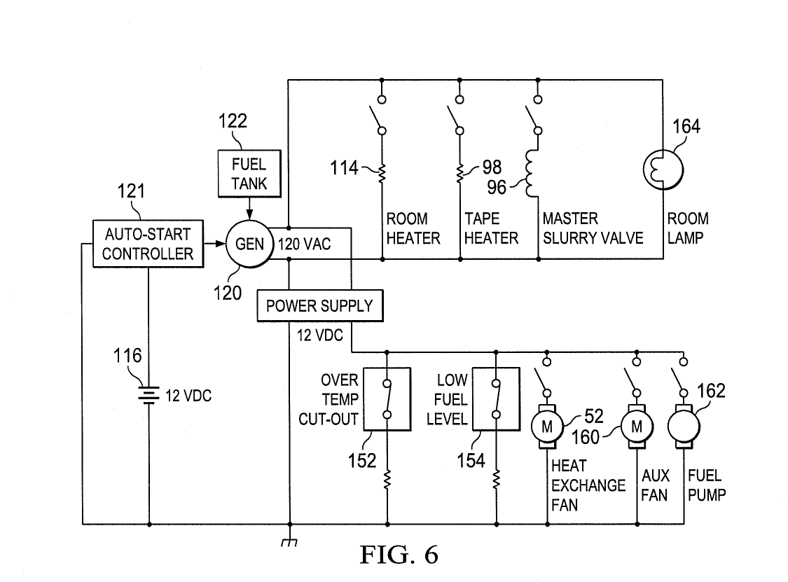

As noted above, the versatility of the uses of the slurry transport apparatus 10 are enhanced by a new combination formed by the transport apparatus 10 and selected heating, cooling, and insulating components that operate under the control of the various sensors and timers well known in the art. In general, the sensors, timers, or other control elements are included as part of the respective thermal management devices unless otherwise stated. These thermal management components will now be described with reference to FIGS. 4, 5, and 6. FIG. 4 is a schematic diagram of the hydraulic, fuel, and engine coolant fluid circuits involved in the thermal management apparatus and processes incorporated in the embodiment of FIGS. 1, 2A and 2B, and 3. FIG. 5 is a plan view schematic diagram of the insulated pump room depicted in FIG. 3. And FIG. 6 is a schematic diagram of the electrical circuits associated with the fluid circuits depicted in FIG. 4.

Referring to FIG. 4, the upper half of the drawing above the hydraulic tank 42 depicts a simplified diagram of the basic hydraulic components of the transport apparatus, including several of the thermal management devices. This is the hydraulic portion of FIG. 4. The lower half of FIG. 4 depicts a simplified diagram of the basic fuel and coolant circulation systems and several other thermal management devices. In the hydraulic portion of FIG. 4 the internal combustion engine 30 drives the main hydraulic pump 78 (which may be a vane-type pump) whose output is directed to a system 160 of flow control valves to supply hydraulic fluid under pressure for the operation of various components of the transport apparatus 10, including the agitator hydraulic motor or drive unit 34 and the hydraulic motor 74 that drives the slurry pump 72. The agitator drive unit 34 and the slurry pump motor 74 are supplied through flow control valves 160 and the respective directional control valves 162, 164 as shown. These flow control 160 and directional control valves 162, 164 are not part of the thermal management system but are shown in the figure to provide functional continuity to the simplified hydraulic system depicted in FIG. 4. Similarly, the relief valve 166 connected at the output of the main hydraulic motor 78 and the filter assembly 168 in the hydraulic fluid return line provide functional continuity to the illustrated hydraulic system.

Continuing with FIG. 4, several components involved in the thermal management system are shown. The heat exchanger 50 (including its electrically operated fan 52) is installed in the return fluid line to ensure that the temperature of the hydraulic fluid does not exceed a practical limit, particularly in warm weather. Two hydraulic fluid warmers 58A and 58B are shown immersed into the hydraulic tank 42. Heated coolant from the diesel fired heater 60 circulates through the fluid warmers 58A and 58B to ensure the temperature of the hydraulic fluid remains within acceptable limits. An over-temperature sensor 152, including NC (normally closed) contacts is provided in the hydraulic fluid tank 42 to signal excessive temperature of the hydraulic fluid as part of the control of the heat exchanger 50. Similarly, a low fuel level sensor 154, including NC contacts is provided in the diesel fuel tank 36 to signal a low fuel condition in the diesel fuel tank 36.

In the lower portion of FIG. 4, a schematic of the fuel and coolant heating networks are illustrated. The diesel fuel from the diesel fuel tank 36 circulates to the diesel engine 30 and continues to the fuel warmer 38 (controlled by thermostat 40) before being returned to the fuel tank 36. Fuel from the fuel tank 36 also supplies the operating fuel for the diesel fired heater 60 via a fuel pump 62. The fuel warmer 38 is warmed by circulating engine coolant from the outlet of the diesel fired heater 60. Coolant from the diesel fired heater 60 also circulates to an inlet to the diesel engine 30 to ensure the temperature of the diesel engine 30 is warmer enough for reliable starting, running, etc. After circulating through the diesel engine 30, the coolant is returned to the fuel warmer and then to the diesel fired heater 60 via the thermostat 40. In the example shown in the drawings, an Espar Diesel Fired Coolant Heater (41,000 Btu, operative under 12 VDC control) is employed as the diesel fired heater 60, which includes a high capacity coolant pump housed in the steel enclosure of the heater. The diesel engine coolant heater 60 also includes an Espar 7 Day timer (not shown) that allows the coolant heater 60 to be controlled without an operator present. These components ensure that the slurry transport 10 will operate reliably and efficiently during cold weather.

The thermal management devices in the insulated room 70 depicted in FIG. 5 include at least a room heater 114 and a heating element 98 such as a tape heater for at least one motorized slurry conduit valve 98. The heating element 98 may be enclosed within an insulated enclosure (not shown in this figure in some embodiments. There may also be sensing devices such as thermostats and timers associated with the critical components of the apparatus in order to sense and determine when the heating devices should be actuated, for example, either on a sensed temperature or timed basis.

The plan view in FIG. 5 also depicts schematically the routing of slurry and water conduits within the insulated pump room 70. The slurry outlet 94 from the slurry tank 12 is conducted to the inlet of the slurry pump 72 via the motorized valve 96. The slurry pump functions by suction to pump the slurry through a first part of conduit 82, a gate valve 84, and a dispensing conduit 86 to a slurry discharge outlet 110 to deliver slurry to a job site. When dispensing is completed the gate valve 84 is closed and fresh water from tank 100 is drawn through conduit 102 and gate valve 106 by the slurry pump 72 and routed via gate valve 88 and the remaining portion of conduit 82 to the slurry tank 12. This process cleans the slurry dispensing apparatus to prevent clogging and reduce maintenance. The water tank 100 may be filled via conduit 104 and gate valve 112.

FIG. 6 is a schematic diagram of the electrical circuits associated with the fluid circuits depicted in FIG. 4. Electrical power for the slurry transport 10 and its various systems is produced by a gasoline fueled generator 120 that is controlled by an auto-start controller 121 powered by a 12 Volt battery 116. Fuel for the generator 120 is stored in a fuel tank 122. The generator 120 provides both 120 VAC for operating lighting and heating devices and 12 Volts DC for operating several fans and fuel pump devices used in the systems. Heating devices include the tape heater 98 and the room heater 114. The master slurry valve 96, a motorized gate valve, and room lamp 164 are also provided with 120 VAC current. The fan 52 for the heat exchanger 50 (see FIGS. 2A and 2B), auxiliary fan 160 (not shown except in FIG. 6), and the fuel pump 62 for the diesel fired heater 60 are provided with 12 Volt operating current from the generator 120. 12 Volt current is also used in the circuits for the over temperature sensor 152 and the low fuel level sensor 154. As noted above, the over-temperature sensor 152, including NC (normally closed) contacts is provided in the hydraulic fluid tank 42 to signal excessive temperature of the hydraulic fluid as part of the control of the heat exchanger 50. Similarly, the low fuel level sensor 154, including NC contacts is provided in the diesel fuel tank 36 to signal a low fuel condition in the diesel fuel tank 36.

### CONCLUSION

The invention described in the foregoing is been provided with several advantages. It is a self-contained, stand alone system that can be automated to run on its own through the use of a suitable timer and control circuits, without requiring that a driver be present for extended periods of time. The unit can run in extremes of hot and cold without the critical components being in danger of freezing or over heating. The novel design incorporates all necessary pumps and distribution lines into one apparatus so that the apparatus of the invention is self-contained in one entity and does not require additional power sources, transportation and manpower expense. The relatively small size of the unit compared to more permanent slurry apparatus means that it is easier to maintain required size and weight limitations for easy highway transportation without additional permits. The present invention is thus an improvement over the prior art in that it allows a wider range of application at smaller (physically and economically) job sites. For example, instead of a typical 20,000 gallon tank capacity present in the prior art vehicles, the present apparatus may have a 10,000 gallon capacity. This allows a product load of say 4,000 gallons of slurry to be carried while moving over the roadway while complying with DOT regulations.

The thermal management facilities included with the transport apparatus, not hitherto available, provide a versatile, thermally enhanced apparatus which can be used in the colder climates present in, for example, the more northern states where agricultural operations are important without the concern of freezing. The temperatures of the engine coolant, engine fuel and the hydraulic fluid, lines, and motors and pumps of the hydraulic system are all maintained within operating temperature limits with regulated heating components and a heat exchanger. A fresh water tank and associated conduits allow the delivery line and associated components to be flushed with fresh water when required and are also valved to allow the flush water to be re-circulated to the tank, rather than dispersing the used water on the surrounding ground.

While the invention has been shown in only one of its forms, it is not thus limited but is susceptible to various changes and modifications without departing from the spirit thereof.

What is claimed is:

1. A thermal management system for a mobile, self-contained lime slurry transport apparatus, comprising:
a self-contained transport apparatus configured to transport and dispense lime slurry to remote job sites, the apparatus supported on a frame of a wheeled chassis and comprising at least a a slurry tank having an internal agitator and a slurry dispensing pump driven respectively by a first and a second hydraulic motor, and a hydraulic system powered by a first internal combustion engine; and
a combination of selectable thermal management devices disposed on the frame of the wheeled chassis and operative to control one or more of at least the temperatures of hydraulic fluid, engine fuel, and engine coolant.

2. The apparatus of claim 1, the thermal management devices comprising:
one or more heating devices selected from the group consisting of a hydraulic fluid warmer, an engine fuel heater, and an engine coolant heater; and
a heat exchanger for limiting temperature rise of the hydraulic fluid.

3. The apparatus of claim 1, the thermal management devices further comprising:
conduits for, respectively, hydraulic fluid, engine fuel, and engine coolant; and
thermal insulation disposed on at least one of respective conduits for hydraulic fluid, engine fuel, and engine coolant.

4. The apparatus of claim 1, the self-contained transport apparatus comprising:
an electric generator powered by a second internal combustion engine for supplying electrical current to at least one electrical device.

5. The apparatus of claim 1, the self-contained transport apparatus comprising:
at least one electrical device selected from the group consisting of a fuel pump, a cooling fan for the heat exchanger, an auto start controller, a diesel fuel line shut off valve, a hydraulic fluid level indicator, and a timing circuit.

6. The apparatus of claim 1, the self-contained transport apparatus comprising:
an insulated enclosure for housing the slurry dispensing pump and the second hydraulic motor;
a conduit system including the second hydraulic pump for conveying slurry from the slurry tank to a job site; and
a thermostatically-controlled electric heater disposed within the insulated enclosure.

7. The self-contained transport apparatus of claim 6, further comprising:
a fresh water tank coupled to the conduit system for flushing the conduit system; and a heater within the insulated enclosure for maintaining water in the water tank in a liquid state.

8. The apparatus of claim 1, wherein the combination of selectable thermal management devices comprises:
a heater disposed inside an insulated enclosure for maintaining an ambient temperature in the insulated enclosure above 32 degrees Fahrenheit.

9. The apparatus of claim 2, wherein the engine fuel heater comprises:
an in-line fuel warmer coupled with a thermostat and installed in a return fuel line from the first internal combustion engine to a first fuel tank.

10. The apparatus of claim 2, wherein the hydraulic fluid heater comprises:
at least one immersion probe heater installed in the hydraulic fluid tank and coupled to an engine coolant conduit between a water jacket outlet of the first internal combustion engine and an inlet to the engine coolant heater.

11. A thermal management system for a single-entity reactor apparatus configured to transport and dispense lime slurry to remote job sites, the reactor apparatus supported on a frame of a wheeled chassis and comprising at least a tank body and a hydraulic tank and hydraulic pump assembly driven by a first internal combustion engine, the thermal management system comprising:
a combination of selectable thermal management devices disposed on the frame of the wheeled chassis and operable to control the temperatures of engine fuel, engine coolant, hydraulic fluid, and water, comprising:
an engine fuel heater;
an engine coolant heater;
a hydraulic fluid heater;
a heat exchanger for the hydraulic fluid; and
a layer of thermal insulation disposed on respective conduits for engine fuel, engine coolant, and hydraulic fluid.

12. The system of claim 11, further comprising:
at least one electrical device selected from the group consisting of an electric wall heater, a fuel pump, a cooling fan for the heat exchanger, a water tank heater, an engine ignition source, an auto start controller, a diesel fuel line shut off valve, and a timing circuit; and
an electric generator powered by a second internal combustion engine for supplying electrical current to the at least one electrical device.
